(19) United States
(12) Patent Application Publication
(10) Pub. No.: US 2026/0268854 A1
(43) Pub. Date: Sep. 10, 2026

(54) Method for display driver circuit and related display driver circuit for setting data reloading

(71) Applicant: NOVATEK Microelectronics Corp., Hsin-Chu (TW)

(72) Inventors: Tso-Hua Chien, Hsinchu City (TW); Po-Sheng Liao, Hsinchu City (TW)

(73) Assignee: NOVATEK Microelectronics Corp., Hsin-Chu (TW)

(21) Appl. No.: 19/235,600

(22) Filed: Jun. 12, 2025

Related U.S. Application Data
(60) Provisional application No. 63/767,548, filed on Mar. 5, 2025.

(51) Int. Cl. G09G 3/3266

(52) U.S. Cl. CPC G09G 3/3266; G09G 2310/0245; G09G 2320/0233; G09G 2320/0247

(57) ABSTRACT

A method for a display driver circuit, which has a first non-refresh period and a first refresh period in a first time period and has a second non-refresh period and a second refresh period in a second time period, includes steps of: receiving, by the display driver circuit, a setting data in the second non-refresh period; and performing, by the display driver circuit, an image processing operation by using the setting data. The second non-refresh period is longer than the first non-refresh period.

### CROSS REFERENCE TO RELATED APPLICATIONS

This application claims the benefit of U.S. Provisional Application No. 63/767,548, filed on Mar. 5th, 2025. The content of the application is incorporated herein by reference.

### BACKGROUND OF THE INVENTION

### 1. Field of the Invention

The present invention relates to a method for a display driver circuit, and more particularly, to a method for a display driver circuit for driving a display panel and the related display driver circuit.

### 2. Description of the Prior Art

A demura compensation technique is usually applied in a display driver circuit, to improve the uniformity of display images on an organic light emitting diode (OLED) panel. The demura compensation requires a great amount of demura data corresponding to the difference between OLED pixels and the required brightness compensation values. The demura data is usually stored in a flash memory, and the display driver circuit (such as a display driver integrated circuit (DDIC)) reloads the demura data to its static random access memory (SRAM) from the flash memory in the booting procedure.

In order to achieve satisfactory visual effects, the OLED panel may need different demura data under different scenarios. As the number of scenarios increases and increases, the required demura data also increases accordingly, which causes that the DDIC should be equipped with a large SRAM, thus increasing the circuit areas and costs. In addition, if the DDIC needs to change the demura data stored in the SRAM, due to the great data amount and the limited read/write speed of the flash, the DDIC is requested to temporarily turn off the demura functions, and then restarts the demura operations after the new demura data is completely reloaded. At this moment, there may be a short-term image variation and/or defect which are easily observed by the user.

### SUMMARY OF THE INVENTION

It is therefore an objective of the present invention to provide a novel method for a display driver circuit, in order to solve the abovementioned problems.

An embodiment of the present invention discloses a method for a display driver circuit. The display driver circuit has a first non-refresh period and a first refresh period in a first time period and has a second non-refresh period and a second refresh period in a second time period. The method comprises steps of: receiving, by the display driver circuit, a setting data in the second non-refresh period; and performing, by the display driver circuit, an image processing operation by using the setting data. The second non-refresh period is longer than the first non-refresh period.

Another embodiment of the present invention discloses a display driver circuit for driving a display panel. The display driver circuit has a first non-refresh period and a first refresh period in a first time period and has a second non-refresh period and a second refresh period in a second time period, and comprises a receiver and an image processing circuit. The receiver is configured to receive a setting data in the second non-refresh period. The image processing circuit, coupled to the receiver, is configured to perform an image processing operation by using the setting data. The second non-refresh period is longer than the first non-refresh period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 illustrates an exemplary implementation of scenario change according to an embodiment of the present invention.

FIG. 3 is a waveform diagram of the display driver circuit according to an embodiment of the present invention.

FIG. 4 is a waveform diagram of the display driver circuit according to another embodiment of the present invention.

FIG. 5 is a schematic diagram of a display system according to an embodiment of the present invention.

FIG. 6 is a schematic diagram of another display system according to an embodiment of the present invention.

FIG. 7 is a flowchart of a process according to an embodiment of the present invention.

### DETAILED DESCRIPTION

As mentioned above, a display driver circuit may encounter the problems that the necessary demura data occupies a great memory space and that the switching of scenarios with demura data change causes a short-term image variation and/or defect. In order to solve the problems, the present invention provides a method to dynamically change demura data, i.e., dynamically receive the demura data under well-controlled display operations, so that the displayed images would not be affected by the change and/or reception of the demura data.

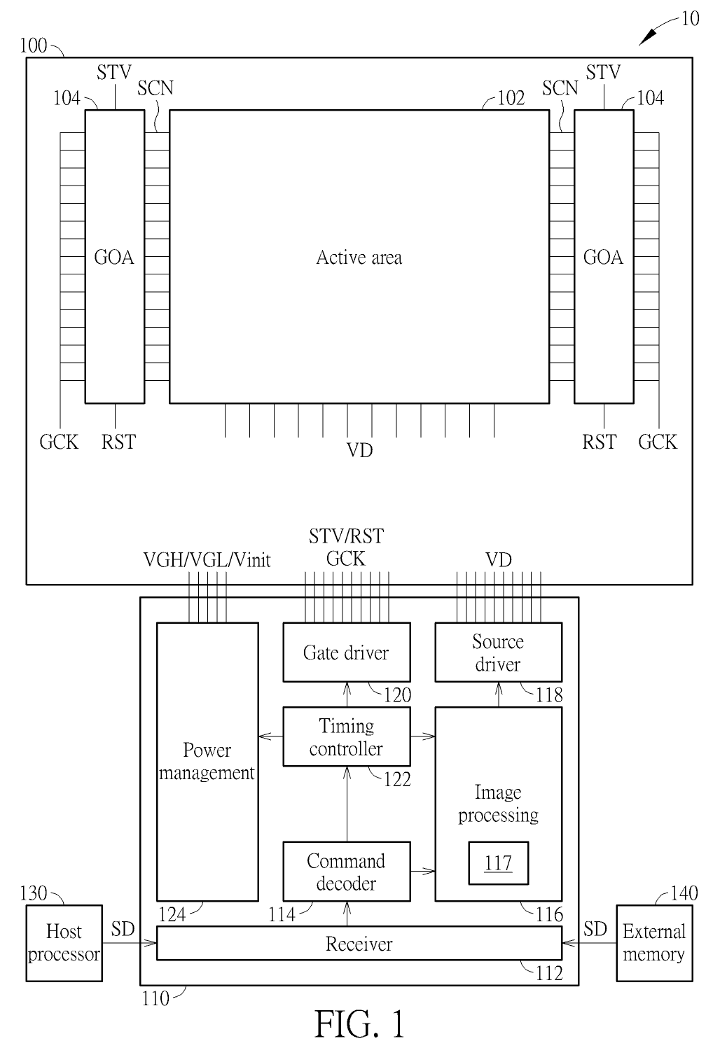

FIG. 1 is a schematic diagram of a display system 10 according to an embodiment of the present invention. The display system 10 includes a display panel 100, a display driver circuit 110, a host processor 130 and an external memory 140. The display panel 100 may be any type of display device, which may be, but not limited to, a light emitting diode (LED) panel, organic LED (OLED) panel, and liquid crystal display (LCD) panel. The display driver circuit 110 is configured to process the image data and convert the image data into data voltages VD to be output to the display panel 100. The display driver circuit 110 may also control various operations of the display panel 100. In one or some embodiments, the display driver circuit 110 may be implemented as an integrated circuit (IC) included in a chip, as a display driver IC (DDIC).

The host processor 130 may be a main processor for controlling the operations of the overall system. As for display operations, the host processor 130 may determine related display settings of the display driver circuit 110, and thus the display driver circuit 110 may be operated under these display settings. In addition, the host processor 130 may serve as a video source to provide input image data for the display driver circuit 110. In one or some embodiments, the display driver circuit 110 may be coupled to the host processor 130 through an interface such as a mobile industry processor interface (MIPI), and thus the input image data are delivered to the display driver circuit 110 through the MIPI. Examples of the host processor 130 may include, but not limited to, an application processor (AP) and a central processing unit (CPU).

The external memory 140 may be a memory coupled to and accessible by the display driver circuit 110. In one or some embodiments, the external memory 140 may be a flash memory, but not limited thereto.

The display panel 100 includes an active area 102 and at least one gate-on-array (GOA) circuit 104. The active area 102 is an area where a pixel array is deployed, where the images are shown on the active area 102 during the display operations. The GOA circuit 104 is usually deployed on the left and/or right side of the active area 102. The GOA circuit 104 may output multiple scan signals SCN (also called gate driving signals) to the pixel array through multiple scan lines (also called gate lines), to control each pixel to be turned on with an appropriate timing to receive the corresponding data voltage VD. In general, the GOA circuit 104 may generate the scan signals SCN by receiving various control signals from the display driver circuit 110. These control signals may include a frame start pulse STV, one or more gate clock signals GCK, and/or a reset signal RST, but not limited herein.

The display driver circuit 110 may control the operations of the display panel 100 by outputting the data voltages VD and correspondingly outputting the control signals to the display panel 100. In detail, the display driver circuit 110 includes a receiver 112, a command decoder 114, an image processing circuit 116, a source driver 118, a gate driver 120, a timing controller 122 and a power management module 124.

The receiver 112 may be coupled to the host processor 130 and/or the external memory 140, and configured to receive setting data SD. As mentioned above, the receiver 112 may be coupled to the host processor 130 through the MIPI, and thus the setting data SD may be received from the host processor 130 through the MIPI. In other embodiments, the receiver 112 may read the setting data SD from the external memory 140 through another interface such as a serial peripheral interface (SPI).

In the embodiments of the present invention, the setting data SD may be any data that is used by the display driver circuit 110 to perform image processing. For example, in an embodiment, the setting data SD may be a demura data. By using the demura data, the display driver circuit 110 may compensate the input image data to generate an output image data, which may further be converted into the data voltages VD to be sent to the display panel 100. In other embodiments, the setting data may be gamma setting data, color temperature setting data, or any other data that could be used by the display driver circuit 110.

Continuing to refer to FIG. 1, the command decoder 114 is coupled to the receiver 112, to decode (e.g., decompress) the image data and/or setting data received through the receiver 112, to convert the data into a form that could be recognized and processed by the image processing circuit 116.

The image processing circuit 116 may perform various image processing operations on the received image data, such as demura, deburn-in, or any other image processing or compensation process capable of improving the visual effects. In one or some embodiments, the image processing operation may be performed by using the setting data SD. For example, if the setting data SD is the demura data, the image processing may be or include a demura compensation serving to improve the brightness inconsistency of the OLED pixels. In general, the image processing circuit 116 may include a memory 117 for storing the setting data SD. The memory 117 may be, for example, a random access memory (RAM), but not limited thereto. After the image processing and/or compensation is completed, the image processing circuit 116 sends the compensated image data to the source driver 118.

The source driver 118 may convert the image data into the data voltages VD to be sent to the pixels on the display panel 100. More specifically, the source driver 118 may include multiple source driving channels, where each channel is coupled to one or more data lines on the display panel 100, to send the data voltages VD to the corresponding data lines, which forward the data voltages VD to the target pixels.

In response to the transmissions of the data voltages VD through the data lines, the scan signals SCN on the display panel 100 should be well controlled to sequentially turn on the target pixels to receive the data voltages VD. As mentioned above, the scan signals SCN forwarded through the scan lines are output by the GOA circuit 104 based on the control signals provided from the display driver circuit 110. Therefore, the display driver circuit 110 may include the gate driver 120, which is configured to output these control signals, including the frame start pulse STV, the gate clock signals GCK and/or the reset signal RST, to the GOA circuit 104.

In order to well control the output timing of the data voltages VD and related control signals, the timing controller 122 may be used for timing control. In various embodiments, the timing controller 122 may generate a vertical synchronization signal and a horizontal synchronization signal for defining the timing of outputting the data voltages VD and related control signals.

The power management module 124 may be configured to supply power to each circuit block in the display driver circuit 110, and may also supply power to the display panel 100. In some embodiments, the power management module 124 may generate some power supply voltages, which are used to determine a logic high voltage VGH and a logic low voltage VGL of the control signals for the GOA circuit 104, and provide the logic high voltage VGH and the logic low voltage VGL for the GOA circuit 104. In some embodiments, the power management module 124 may generate one or more initial voltages Vinit (also referred to as reset voltages), which are provided for the pixels on the display panel 100 for initialization.

In some embodiments, the display system 10 may be switched between different scenarios, and thus the display driver circuit 110 may be provided with different setting data under different scenarios. For example, supposing that the display system 10 is in a first scenario where the display driver circuit 110 processes the image data by using a first setting data, if the display system 10 is requested to be switched to a second scenario from the first scenario, the display driver circuit 110 should use a second setting data instead of the first setting data to process the image data. In such a situation, the display driver circuit 110 may receive the second setting data from the host processor 130 or the external memory 140 through the receiver 112.

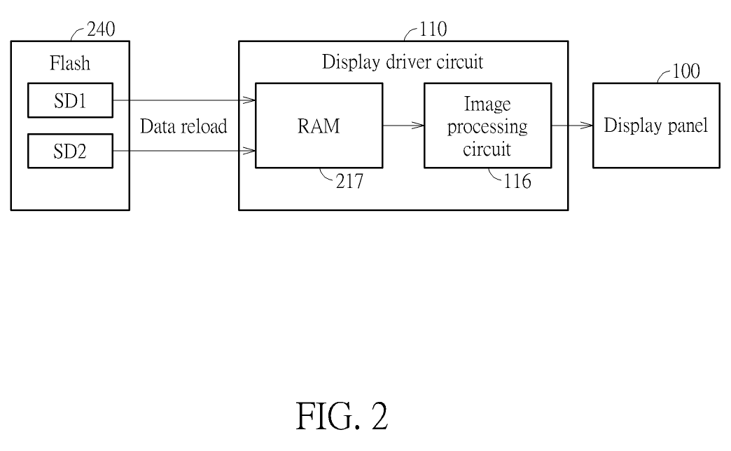

FIG. 2 illustrates an exemplary implementation of scenario change according to an embodiment of the present invention. The display driver circuit 110 may be operated in a 1-anode reset mode or a multi-anode reset mode. The anode reset is usually applied to an OLED panel, to reset the anode of the OLED in the pixels. During the anode reset operation, the display driver circuit 110 may forcibly turn on one or some transistors (e.g., through the GOA circuit 104) to send a reset voltage to the anode of the OLED, thereby resetting the anode voltage of the OLED to a specific level. In the 1-anode reset mode, the OLED anode may be reset once in a frame period; and in the multi-anode reset mode, the OLED anode may be reset multiple times in a frame period.

However, the display images may have exactly different Mura behaviors under the 1-anode reset mode and the multi-anode reset mode; hence, the required demura data for different operation modes will be different. As shown in FIG. 2, it is assumed that the display driver circuit 110 receives the setting data from a flash memory 240, which may be an implementation of the external memory 140 shown in FIG. 1. The setting data may include a first setting data SD1 suitable for the 1-anode reset mode and a second setting data SD2 suitable for the multi-anode reset mode, and these setting data SD1 and SD2 are usually stored in the flash memory 240. More specifically, the setting data SD1 is a demura data used to compensate for the Mura generated in the 1-anode reset mode, and the setting data SD2 is a demura data used to compensate for the Mura generated in the multi-anode reset mode. Since the 1-anode reset mode and the multi-anode reset mode have exactly different Mura behaviors, the setting data SD1 and SD2 will be exactly different.

Therefore, when the display driver circuit 110 is to be operated in the 1-anode reset mode, it may reload the first setting data SD1 from the flash memory 240, where the first setting data SD1 may be stored into a RAM 217, which may be an exemplary implementation of the memory 117 of the display driver circuit 110. The image processing circuit 116 thereby takes the first setting data SD1 from the RAM 217 to compensate the image data in the 1-anode reset mode. If the display driver circuit 110 is switched to be operated in the multi-anode reset mode, it may reload the second setting data SD2 from the flash memory 240, where the second setting data SD2 may be stored into the RAM 217 to replace the setting data SD1. The image processing circuit 116 thereby takes the second setting data SD2 from the RAM 217 to compensate the image data in the multi-anode reset mode. In such a situation, the memory space of the RAM 217 is requested to accommodate the demura data of only one operation mode, which saves the circuit areas for memory space under multiple different scenarios, especially when there are more scenarios that need different demura data.

In addition, the setting data may be received in an appropriate manner to reduce or eliminate its influence on the image display. In other words, the images are requested to be displayed normally when the display driver circuit reloads the demura data in response to the switching of scenario, to avoid unwanted defects of visual effects such as flickers.

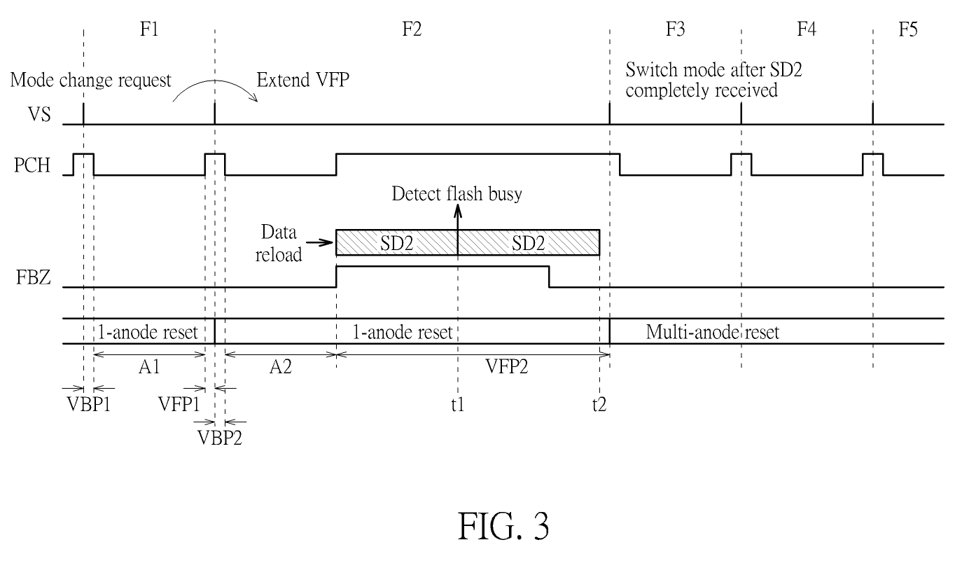

FIG. 3 is a waveform diagram of the display driver circuit 110 according to an embodiment of the present invention, where the waveforms of a vertical synchronization signal VS, a porch indication signal PCH and a flash busy indication signal FBZ are shown. FIG. 3 also illustrates the operation mode of the display system 10 to facilitate the illustrations, where the operation mode includes a 1-anode reset mode and a multi-anode reset mode, as similar to the above embodiment.

As shown in FIG. 3, each image frame F1-F5 may include a refresh period and two non-refresh periods, and the non-refresh periods include a vertical back porch (VBP) and a vertical front porch (VFP). In detail, the image frame F1 proceeds with a VBP VBP1, a refresh period A1 and a VFP VFP1 sequentially, the image frame F2 proceeds with a VBP VBP2, a refresh period A2 and a VFP VFP2 sequentially, and so on. Assuming that the display system 10 is operated in the 1-anode reset mode initially, and thus the display driver circuit 110 may apply the setting data SD1 for the 1-anode reset mode to perform demura compensation in the first image frame F1, where the setting data SD1 is already received by and stored into the display driver circuit 110 at a previous time point. Therefore, the VFP VFP1 may have a normal length since there is no setting data received in the VFP VFP1.

Subsequently, the display driver circuit 110 may receive or obtain a mode change request at the end of the image frame F1, where the mode change request indicates that the operation mode needs to be switched to the multi-anode reset mode, and thus the display driver circuit 110 may start to reload the setting data SD2 from the external memory 140 (or the host processor 130). Therefore, in the next image frame F2, the VFP VFP2 is extended for receiving the setting data SD2, which is the demura data used for the multi-anode reset mode, so that the VFP VFP2 of the image frame F2 will be longer than the VFP VFP1 of the image frame F1.

In the VFP VFP2 of the image frame F2, the display driver circuit 110 may monitor whether the setting data SD2 is completely received, thereby determining the extended length of the VFP VFP2. In some embodiments, the display driver circuit 110 may detect a refresh indication signal to determine whether the setting data is completely received. According to the result of whether the setting data is completely received, the display driver circuit 110 may determine to further extend the VFP VFP2 or start the next image frame F3.

For example, in the embodiment shown in FIG. 3, the setting data SD2 may be reloaded from a flash memory, which may send a flash busy indication signal FBZ to the display driver circuit 110, where the flash busy indication signal FBZ indicates the operational state of the flash memory. Therefore, the flash busy indication signal FBZ may serve as the refresh indication signal that is used by the display driver circuit 110 to determine whether the setting data is completely received. For example, as shown in FIG. 3, the flash busy indication signal FBZ may be a flag signal. The flash busy indication signal FBZ in “high” level indicates that the flash memory is busy for outputting the setting data SD2, while in “low” level indicates that the flash memory is idle. In such a situation, the display driver circuit 110 may determine that the setting data SD2 is already completely received when detecting that the flash busy indication signal FBZ goes “low”.

As shown in FIG. 3, the VFP VFP2 may first be extended by a predetermined length to a time point t1. At the time point t1, the display driver circuit 110 detects that the flash memory is still busy according to the flash busy indication signal FBZ, and thus further extends the VFP VFP2 by another length. Subsequently, at the time point t2, the display driver circuit 110 detects that the flash memory is idle according to the flash busy indication signal FBZ, which means that the setting data SD2 is completely received. At this time, the display driver circuit 110 may start the next image frame F3 with the operation mode switched to the multi-anode reset mode. In the image frame F3 and subsequent image frames, the image data will be compensated by using the setting data SD2 for the multi-anode reset mode, and the VFP returns to its normal length until the next mode change request is received.

In such a situation, the demura data is reloaded in a time period (i.e., a VFP) where the image data of the display panel is not refreshed, and thus the image display may not be influenced by the replacement of the demura data. As a result, the visual effect problem due to demura data change may be mitigated or eliminated.

Please note that the present invention aims at providing a novel method of dynamically extending a non-refresh period for reloading setting data from an external device to the display driver circuit. Those skilled in the art may make modifications and alterations accordingly. For example, in the above embodiments, the setting data is demura data used for compensating the inconsistency of OLED pixels. In another embodiment, the setting data may be any other possible data for image processing, such as gamma setting data or color temperature setting data, but not limited thereto. In addition, in the above embodiments, different setting data are used for different operation modes having different anode reset behaviors. In another embodiment, different setting data may be required for different scenarios or operation modes in another aspect. For example, in an OLED panel, the duty cycle and/or the number of emission pulses of an emission control signal may be different when the display panel performs display with different brightness settings. In one or some embodiments, the change of emission control may also result in different Mura behaviors, which require different demura data for compensation. In such a situation, the demura data may be reloaded when the operation mode of emission control is switched. Note that there may be any number of setting data stored in the external memory and to be reloaded into the display driver circuit when the corresponding scenario or operation mode is to be applied.

Further, in the above embodiment, the VFP is extended for receiving the setting data. In another embodiment, the setting data may be reloaded in another manner to avoid the influence on image data reception.

In a display system capable of dynamic frame rate allocation, each frame period may be allocated to an active frame or a blanking frame (also referred to as skip frame) based on the requirements of frame rate (also referred to as refresh rate). The active frame is a refresh period where the image data on the display panel is refreshed, and the blanking frame is a non-refresh period where the image data on the display panel is not refreshed. Therefore, in one or some embodiments, the display driver circuit may allocate a specific number of blanking frames for receiving the setting data.

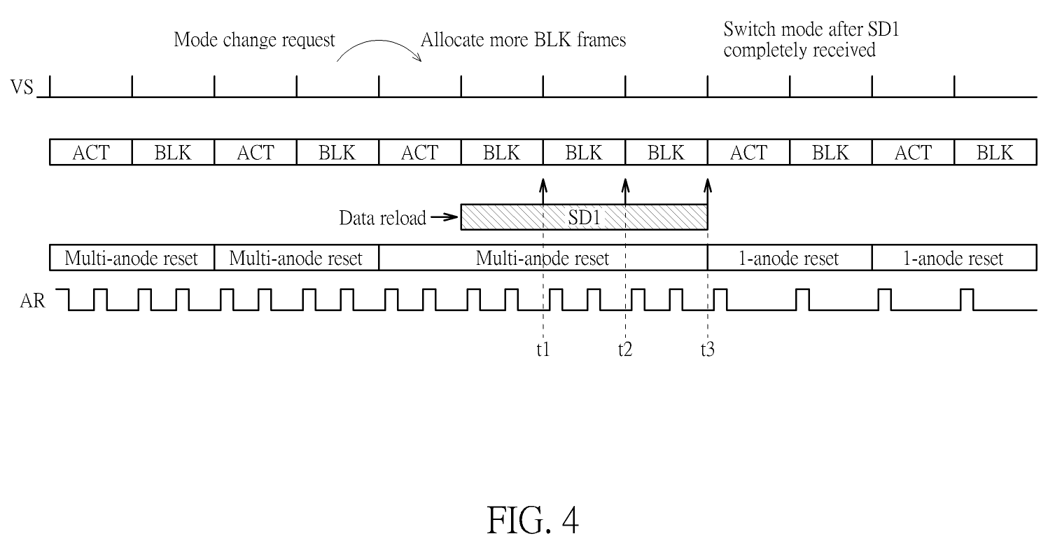

FIG. 4 is a waveform diagram of the display driver circuit 110 according to another embodiment of the present invention. FIG. 4 illustrates the waveforms of the vertical synchronization signal VS and an anode reset signal AR. The operation mode of the display system 10 and the allocation of frame periods are also shown in FIG. 4 to facilitate the illustrations.

As shown in FIG. 4, each frame period may be allocated to an active frame (ACT) or a blanking frame (BLK). Assuming that the display system 10 is operated in the multi-anode reset mode initially, and thus the display driver circuit 110 may apply the setting data SD2 for the multi-anode reset mode to perform demura compensation, where the setting data SD2 is already received by and stored into the display driver circuit 110 at a previous time point. At this time, the anode reset signal AR has two pulses in each frame period, which means that the display system 10 is in the multi-anode reset mode. In this embodiment, the image frames are predetermined to be displayed in 60 Hz, and thus the frame periods are allocated to have one active frame and one blanking frame appearing alternately when no setting data reception is performed.

Subsequently, the display driver circuit 110 may receive or obtain a mode change request indicating that the operation mode needs to be switched to the 1-anode reset mode, and thus the display driver circuit 110 may start to reload the setting data SD1 from the flash memory 240. Therefore, after the end of the next active frame, the display driver circuit 110 may allocate more blanking frames for receiving the setting data SD1.

Similarly, during the non-refresh period for receiving the setting data SD1, the display driver circuit 110 may monitor whether the setting data SD1 is completely received according to a refresh indication signal. For example, at the time points t1 and t2, the display driver circuit 110 detects that the reception of the setting data SD1 has not been completed, and thus allocates another blanking period. Subsequently, at the time point t3, the display driver circuit 110 detects that the setting data SD1 is completely received, and thus may start the next active frame with the operation mode switched to the 1-anode reset mode. As shown in FIG. 4, after the operation mode is switched to the 1-anode reset mode, the anode reset signal AR has only one pulse in each frame period, which means that the anode reset is performed once in each frame period.

In such a situation, the demura data is reloaded in a time period (i.e., blanking frame) where the image data of the display panel is not refreshed, and thus the image display may not be influenced by the replacement of the demura data. As a result, the visual effect problem due to demura data change may be mitigated or eliminated.

In another embodiment, the display system may be capable of multi-frequency display (MFD), where different areas of the display panel are provided with different frame rates. In such a situation, the frame rate of each area may be well controlled to let the setting data to be reloaded in a non-refresh period. In this embodiment, the display driver circuit 110 may receive an MFD control signal (e.g., from the host processor 130). The MFD control signal is a signal capable of disabling the refresh of the entire frame. When the display driver circuit 110 is receiving or reloading the setting data, the MFD control signal may be triggered to forcibly disable the refresh operations. In such a situation, the display driver circuit 110 may monitor the MFD control signal to determine whether the setting data is completely received, thereby proceeding with another non-refresh period (e.g., blanking frame) or starting a new refresh period (e.g., active frame). The detailed operations under the MFD control could be inferred by those skilled in the art according to the above descriptions related to FIG. 4, and will not be narrated herein.

In various embodiments of the present invention, the setting data may be reloaded from the flash memory or received from the host processor in any manner. For example, in the embodiment as shown in FIG. 1, the setting data SD may be directly reloaded from the external memory 140 to be stored in the memory 117 of the display driver circuit 110. In other embodiments, the setting data may be reloaded or obtained in other manners.

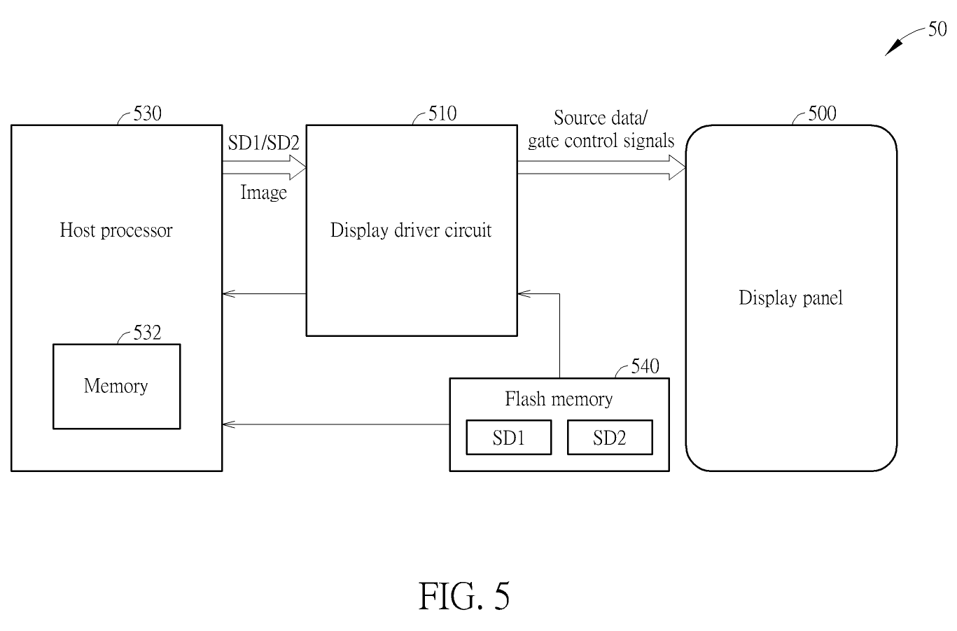

FIG. 5 is a schematic diagram of a display system 50 according to an embodiment of the present invention. The display system 50 includes a display panel 500, a display driver circuit 510, a host processor 530 and a flash memory 540. The host processor 530 may send image data to the display driver circuit 510, and the display driver circuit 510 may output corresponding source data voltages and gate control signals to the display panel 500 to control the display operations. As shown in FIG. 5, the flash memory 540 stores a setting data SD1 for a first scenario/operation mode (e.g., the 1-anode reset mode) and a setting data SD2 for a second scenario/operation mode (e.g., the multi-anode reset mode).

In this embodiment, in the booting procedure of the display system 50, the setting data SD1 and SD2 may be loaded to the host processor 530 from the flash memory 540, and then stored in a memory 532 of the host processor 530. In general, the host processor 530 is responsible for controlling the overall operations of the electronic device and thus may have a large storage space in its memory 532, which is enough to store the information of all the setting data required by the display driver circuit 510. In an exemplary embodiment, the host processor 530 may directly read the setting data SD1 and SD2 from the flash memory 540. Alternatively, the setting data SD1 and SD2 may be sent to the display driver circuit 510, which then forwards the setting data SD1 and SD2 to the host processor 530. Note that FIG. 5 shows that the memory 532 is included in the host processor 530, but in another embodiment, the memory 532 may be an external memory connected to and accessible by the host processor 530.

Subsequently, the display driver circuit 510 may know that the display system 50 is operated in which operation mode, and receive the corresponding setting data from the host processor 530 accordingly. Therefore, when the operation mode of the display system 50 is switched, the host processor 530 may send the setting data SD1 or SD2 to the display driver circuit 510 based on the operation mode, e.g., through the MIPI connected between the host processor 530 and the display driver circuit 510. Compared to the SPI usually used for the flash memory 540, the MIPI can provide a faster transmission speed, thereby reducing the time consumption required for forwarding/reloading the setting data when the scenario or operation mode changes. In such a situation, the display driver circuit 510 may allocate a shorter non-refresh period for receiving the setting data, which may further avoid unwanted side effects due to the frame rate reduction resulting from the reception of setting data.

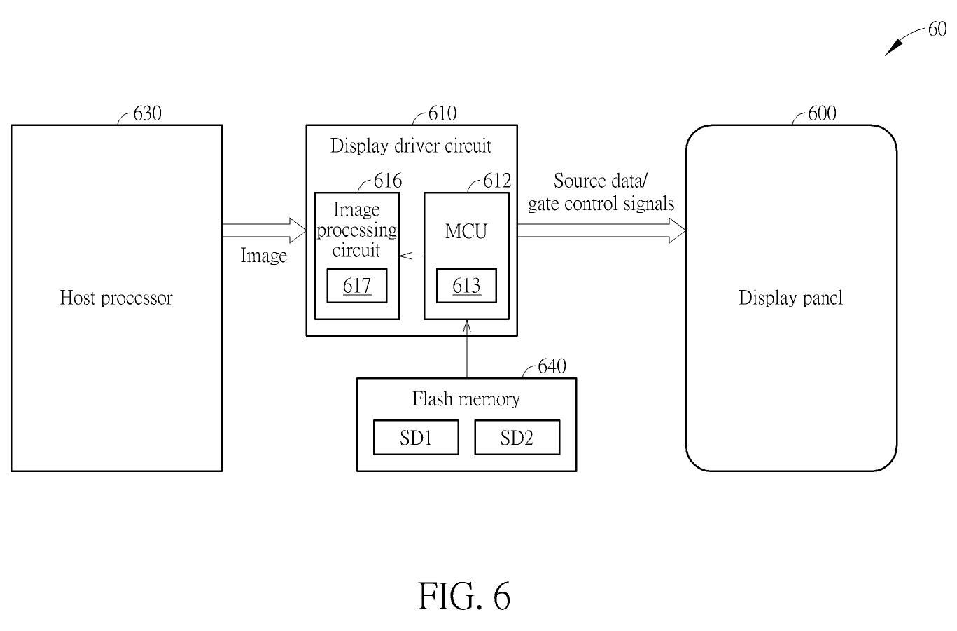

FIG. 6 is a schematic diagram of another display system 60 according to an embodiment of the present invention. The display system 60 includes a display panel 600, a display driver circuit 610, a host processor 630 and a flash memory 640. Similarly, the host processor 630 may send image data to the display driver circuit 610, and the display driver circuit 610 may output corresponding source data voltages and gate control signals to the display panel 600 to control the display operations. As shown in FIG. 6, the flash memory 640 stores a setting data SD1 for a first scenario/operation mode (e.g., the 1-anode reset mode) and a setting data SD2 for a second scenario/operation mode (e.g., the multi-anode reset mode).

In this embodiment, the display driver circuit 610 includes a microcontroller unit (MCU) 612 and an image processing circuit 616, where the MCU 612 is deployed with a memory 613, and the image processing circuit 616 is deployed with another memory 617. Each of the memories 613 and 617 may be, for example, a RAM, but not limited thereto. In the booting procedure of the display system 60, the setting data SD1 and SD2 may be reloaded to the MCU 612 from the flash memory 640, and then stored in the memory 613 of the MCU 612.

Subsequently, the display driver circuit 610 may know that the display system 60 is operated in which operation mode, and the MCU 612 may send the corresponding setting data to the image processing circuit 616 accordingly. Therefore, when the operation mode of the display system 60 is switched, the setting data SD1 or SD2 stored in the memory 613 of the MCU 612 may be reloaded to the image processing circuit 616 based on the operation mode. This setting data reloading is an intra-chip transmission, which is usually faster than the reload speed from the flash memory 640. Therefore, the time consumption required for forwarding/reloading the setting data may be reduced. In such a situation, the display driver circuit 610 may allocate a shorter non-refresh period for receiving the setting data, which may further avoid unwanted side effects due to the frame rate reduction resulting from the reception of setting data.

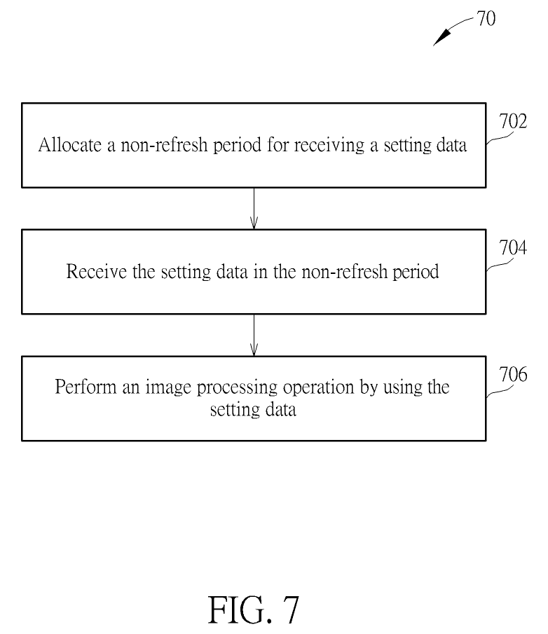

The abovementioned operations of the display driver circuit may be summarized into a process 70, as shown in FIG. 7. The process 70 may be implemented in a display driver circuit, such as the display driver circuit 110, 510 or 610 in the above embodiment. As shown in FIG. 7, the process 70 includes the following steps:

Step 702: Allocate a non-refresh period for receiving a setting data.

Step 704: Receive the setting data in the non-refresh period.

Step 706: Perform an image processing operation by using the setting data.

The detailed operations and alterations of the process 70 are illustrated in the above descriptions, and will not be narrated herein.

To sum up, the present invention provides a method of dynamically reloading setting data from an external memory to the display driver circuit. In one or some embodiments, the setting data may be a demura data used for compensating for the Mura in the image data. Since different demura data are applicable to different scenarios, when the scenario or operation mode changes, the display driver circuit may reload the corresponding demura data from the external memory. In some embodiments, the display driver circuit may allocate a non-refresh period for reloading the setting data, where the non-refresh period may be a VFP, one or more blanking frames, or any other time period in which no panel refresh is performed. The display driver circuit is then switched to the new scenario or operation mode after the setting data is completely received. In such a situation, the image display will not be affected by the reception/reloading of the setting data, so as to successfully replace the setting data while the influence on visual effects may be minimized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a display driver circuit, the display driver circuit having a first non-refresh period and a first refresh period in a first time period and having a second non-refresh period and a second refresh period in a second time period, the method comprising: receiving, by the display driver circuit, setting data in the second non-refresh period; and
performing, by the display driver circuit, an image processing operation for at least one third time period subsequent to the second time period by using the setting data,
wherein the second non-refresh period is longer than the first non-refresh period,and wherein the setting data are demura data corresponding to a plurality of pixels.

2. The method of claim 1, further comprising:receiving, by the display driver circuit, no setting data in the first non-refresh period.

3. The method of claim 1, wherein an original setting data is used for a first scenario and the received setting data is used for a second scenario, and wherein the display driver circuit receives the setting data when switched to the second scenario from the first scenario.

4. The method of claim 1, further comprising:detecting, by the display driver circuit, a refresh indication signal to determine whether the setting data is completely received in the second non-refresh period, to generate a detection result.

5. The method of claim 4, further comprising: determining, by the display driver circuit, whether to further extend the second non-refresh period according to the detection result.

6. The method of claim 4, wherein the refresh indication signal comprises at least one of a flash busy indication signal and a multi-frequency display (MFD) control signal.

7. The method of claim 1, wherein each of the first non-refresh period and the second non-refresh period is a vertical front porch (VFP).

8. The method of claim 7, further comprising:extending, by the display driver circuit, the VFP in the second time period for receiving the setting data.

9. The method of claim 1, wherein the first non-refresh period comprises a first number of non-refresh frames and the second non-refresh period comprises a second number of non-refresh frames, and the second number is greater than the first number.

10. The method of claim 9, further comprising: allocating, by the display driver circuit, the second number of non-refresh frames in the second time period for receiving the setting data.

11. (canceled)

12. The method of claim 1, wherein the step of performing the image processing operation by using the setting data comprises: compensating, by the display driver circuit, an input image data by using the
demura data to generate an output image data.

13. A display driver circuit for driving a display panel, the display driver circuit having a first non-refresh period and a first refresh period in a first time period and having a second non-refresh period and a second refresh period in a second time period, and comprising: a receiver to receive setting data in the second non-refresh period; and an image processing circuit, coupled to the receiver, to perform an image processing operation for at least one third time period subsequent to the second time period by using the setting data,
wherein the second non-refresh period is longer than the first non-refresh period,and wherein the setting data are demura data corresponding to a plurality of pixels.
